(19) United States
(12) Patent Application Publication
(10) Pub. No.: US 2011/0105204 A1
(43) Pub. Date: May 5, 2011

(54) SLIDING-TYPE PORTABLE TERMINAL

(75) Inventor: Kazunori Kouno, Kanagawa (JP)

(73) Assignee: Panasonic Corporation, Osaka (JP)

(21) Appl. No.: 13/001,600

(22) PCT Filed: Feb. 27, 2009
(86) PCT No.: PCT/JP2009/000914

§ 371 Date: Dec. 27, 2010

(30) Foreign Application Priority Data
Jun. 27, 2008 (JP) 2008-168828

(51) Int. Cl. H04M 1/00

(52) U.S. Cl. 455/575.4

(57) ABSTRACT

Provided is a thin and small sliding-type portable terminal which has improved operability. In a portable terminal (100), a first case (110) has an upper surface section (114) which includes an operation surface section (112) whereupon operation keys (112a) are arranged. A second case (130) is provided with a display surface (134), connected to the first case (110) through a slider (154), and is permitted to move from a position where the second case overlaps with the first case on the upper surface section (114) to an exposing position where the operation surface section (112) is exposed to the outside. The slider (154) is attached to the first case (110) such that the slider can freely slide in a linear direction from the position where the slider overlaps with the first case to the exposing position, and the slider rotatably supports the second case (130) along the sliding surface by means of a shaft which orthogonally intersects with the sliding direction. The second case (130) slides along a tilted section (120) of the first case (110) with movement of the slider (154). Thus, an intersection surface of the display surface (134) and the operation surface section (112) has an obtuse angle.

### TECHNICAL FIELD

The present invention relates to a sliding-type portable terminal.

### BACKGROUND ART

Hitherto, with regard to mobile phones functioning as portable terminals, a sliding-type portable terminal has been known, for example, in which a first case functioning as a calling part provided with operating keys on its upper surface, and a second case functioning as a receiver part with a display surface located on its upper surface, are joined together.

With a sliding-type portable terminal, a transition is made from a state in which the second case covers the upper surface of the second case and completely overlaps the first case (a closed state) to a state in which input is possible by means of operating keys (an open state) by sliding the second case longitudinally and parallel to the first case and exposing the operating keys on the upper surface of the first case.

With a sliding-type portable terminal of Patent Literature 1, in a state in which input is possible by means of operating keys (an open state), the surface of the first case on which operating keys are located and the upper surface of the second case on which a display surface is located are parallel since the second case slides upon the first case parallel to the first case. Therefore, when a user uses the portable terminal, the user operates operating keys on the first case while maintaining an angle at which the display surface of the second case is easy to view, by adjusting the angle at which the first case is held. Thus, a problem in the case of Patent Literature 1 is that, when the display surface of the second case is made easy to view, the upper surface of the first case on which the operating keys are located is tilted upward by the user, and the operating keys become difficult to press.

Consequently, as shown in Patent Literature 2, for example, a configuration is known whereby, when a sliding-type portable terminal is in the open state, the display surface of the upper surface of the upper case is placed in a position where it is inclined with respect to the surface of the lower case on which the operating keys are located.

With this configuration, an upward-curving platform part is provided along the entire area of both side parts in the longitudinal direction of the upper surface of the lower case, and a skirt part with its bottom edge curved downward in accordance with the shape of the platform part is provided along the entire area of both side parts in the longitudinal direction of the upper case positioned overlapping the lower case.

The skirt part is located so as to be on either side of the upper surface of the lower case, and is formed in series so as to be able to slide along the platform part. On the inner side of this skirt part a guide groove is provided that curves upward parallel to the platform part, and a convex part provided on the lower case is inserted in a slidable fashion in this guide groove.

By this means, the upper case is guided by the curved surface of the platform part of the lower case with respect to that lower case, the sliding end side thereof rises upward from a horizontal state, a obtuse angle having the shape of the letter V from the side view, is formed on the side surface relative to the lower case, and the upper surface of the upper case is positioned inclined with respect to the upper surface on which operating keys are located on the lower case.

### Citation List

### Patent Literature

### [PTL 1] Japanese Patent Application Laid-Open No. 2003-125052

### [PTL 2] Japanese Patent Application Laid-Open No. 2004-235897

### SUMMARY OF INVENTION

### Technical Problem

However, with a conventional sliding-type mobile phone configuration whereby the upper surface of the upper case is moved to a position where it is inclined with respect to the upper surface of the lower case, the lower case and the upper case overlapping the lower case are deployed on a rail that curves upward as viewed from the side (equivalent to a skirt part), and therefore the thickness of the mobile phone itself increases by the height from the bottom to the top of the rail.

Also, in a configuration using an above-described curved rail, a convex part, which is detachably engaged in a guide groove of the skirt part in the upper case, is provided in a platform part. And, the guide groove is formed by notching both sides of the upper surface section of the lower case. Therefore it is necessary to increase the lateral width of the lower case itself from the standpoint of the footprint inside the upper surface section of the lower case.

Thus, a problem with a sliding-type mobile phone configuration of Patent Literature 1 is that it is difficult to achieve the thinness and small size of a mobile phone itself necessary for achieving the portability of a terminal itself that is a recent trend in portable terminals such as mobile phones. Furthermore, with a conventional portable terminal, the skirt part is exposed on the lower surface section of the tip (rear) of the upper case in the operating state—that is, the open state—and there is consequently a demand for a design approach that avoids this exposure.

It is therefore an object of the present invention to provide a sliding-type portable terminal that enables thinness and small size to be achieved together with an improvement in operability.

### Solution to Problem

A sliding-type portable terminal of one aspect of the present invention is provided with a first case having one surface that includes an operation surface on which operating keys are located, and a second case that has a display section on the surface side, and is connected to the first case so as to be movable from an overlapping position on the one surface to an exposing position where the operation surface is exposed to the outside; and this sliding-type portable terminal employs a configuration having: a sliding member that is attached to the first case so as to be able to slide freely in a linear direction from the overlapping position to the exposing position, and rotatably supports the second case along a sliding surface on an axis placed orthogonal to the sliding direction; and an inclined section that is provided on the first case, and on which the second case slides together with sliding of the sliding member in a linear direction, and that causes the surface of the second case to incline toward the operation surface side.

### ADVANTAGEOUS EFFECTS OF INVENTION

According to the present invention, in a sliding-type portable terminal a second case slides together with sliding of a sliding member in a linear direction, the upper surface of the second case inclines toward the operation surface side, the intersecting plane of the surface of the second case and the operation surface of the first case form an obtuse angle, and thinness and small size can be achieved together with an improvement in operability.

### BRIEF DESCRIPTION OF DRAWINGS

FIG. 1 is a principal-part exploded perspective view of a sliding-type portable terminal according to an embodiment of the present invention;

FIG. 2 is a perspective view showing a sliding-type portable terminal according to an embodiment of the present invention;

FIG. 3 is a perspective view showing a sliding-type portable terminal according to an embodiment of the present invention;

FIG. 4 is a drawing showing a principal-part configuration of a sliding-type portable terminal according to this embodiment;

FIG. 5 is a principal-part cross-sectional diagram showing a structure for attachment of a roller to a second case in a sliding-type portable terminal according to this embodiment;

FIG. 6 is a principal-part side view provided to explain an operation whereby a second case is slid with respect to a first case in a sliding-type portable terminal according to this embodiment;

FIG. 7 is a principal-part side view provided to explain an operation whereby a second case is slid with respect to a first case in a sliding-type portable terminal according to this embodiment; and

FIG. 8 is a principal-part side view provided to explain an operation whereby a second case is slid with respect to a first case in a sliding-type portable terminal according to this embodiment.

### DESCRIPTION OF EMBODIMENTS

Now, an embodiment of the present invention will be described in detail with reference to the accompanying drawings. In this embodiment, a case is described in which a sliding-type portable terminal is applied to a mobile phone, but a sliding-type portable terminal may also be applied to a PHS, PDA, or suchlike small portable information terminal, a portable television receiver such as a One-Seg (one-segment broadcasting) compatible receiver, a portable game machine, and so forth.

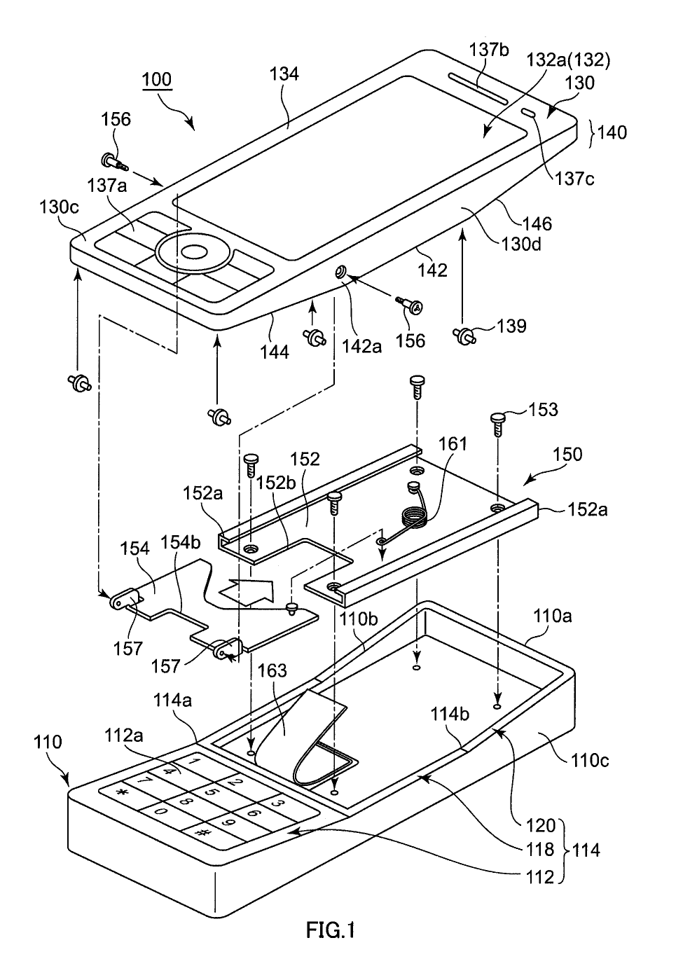

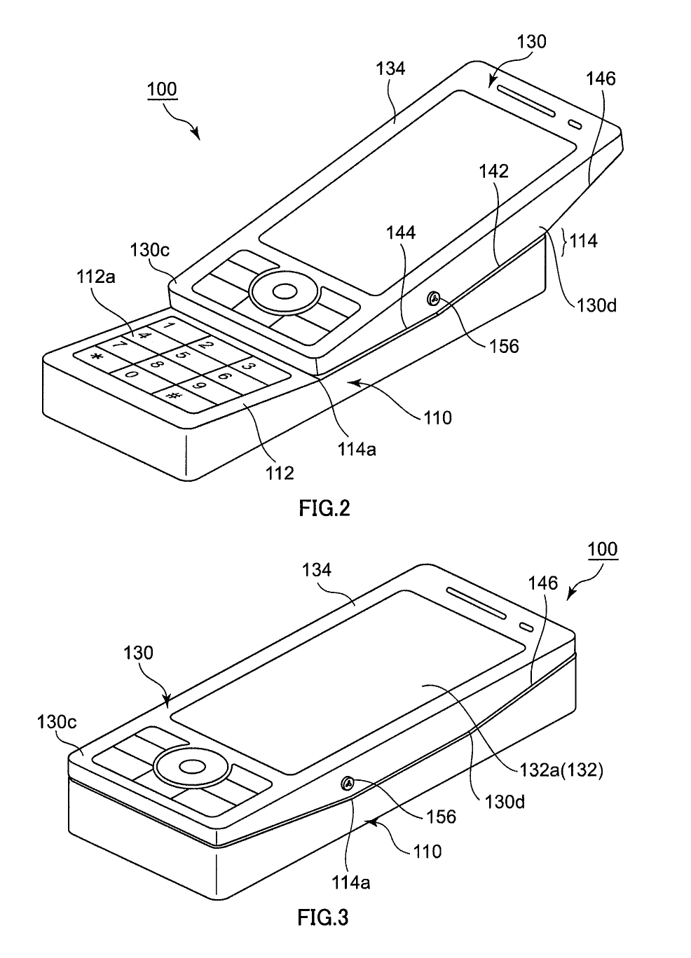

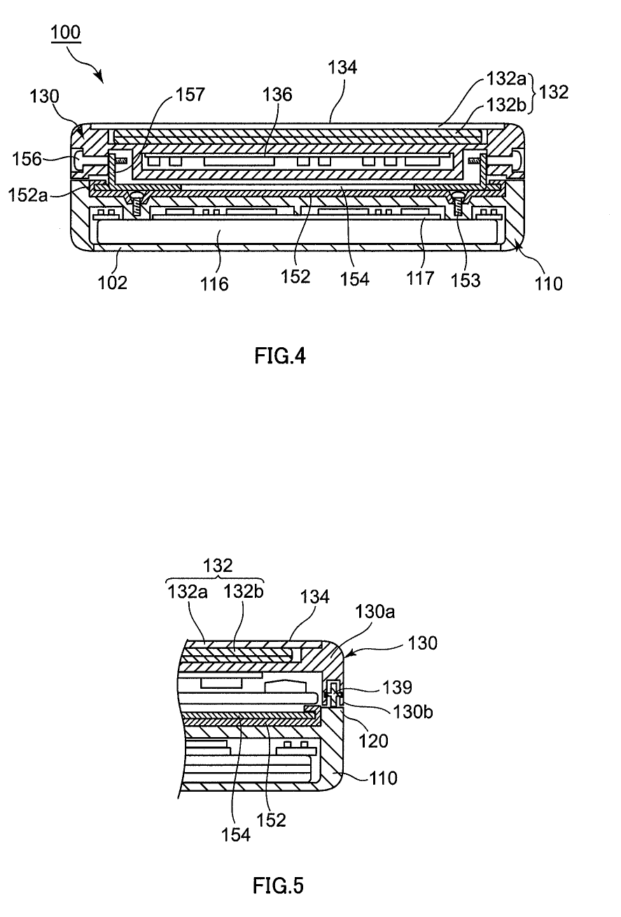

FIG. 1 is a principal-part exploded perspective view of a sliding-type portable terminal according to an embodiment of the present invention, and FIG. 2 and FIG. 3 are perspective views showing a sliding-type portable terminal according to an embodiment of the present invention. FIG. 2 is a perspective view showing a state in which operating keys on the sliding-type portable terminal can be used (an open state), and FIG. 3 is a perspective view showing a state in which operating keys on the sliding-type portable terminal cannot be used (a closed state). FIG. 4 is a drawing showing a principal-part configuration of a sliding-type portable terminal according to this embodiment, being a principal-part cross-sectional diagram of a second case connecting part in the sliding-type portable terminal.

In this embodiment, “up”, “down”, “left”, and “right” mean up, down, left, and right when viewing the above sliding-type portable terminal with the first case at the bottom. Also, in this embodiment, “rear” means the end of the above sliding-type portable terminal toward which the sliding second case slides from a position in which it covers the first case, and the opposite end thereto is designated the “front”.

Sliding-type portable terminal 100 of this embodiment shown in FIG. 1 has first case 110 having upper surface section 114 on which operating keys 112a are arranged, and second case 130 that is attached to first case 110 in a slidable fashion via slide mechanism section 150 and is provided with display surface 132.

When second case 130 overlaps upper surface section 114 of first case 110, sliding-type portable terminal 100 is approximately flat and rectangular in shape (see FIG. 2), and first case 110 is placed in an operational state in which operating keys 112a are exposed to the outside by sliding second case 130 upon first case 110 (see FIG. 2).

In this sliding-type portable terminal 100 operational state, as shown in FIG. 2, upper surface (display surface) 134 of second case 130 on which display surface 132 is provided is placed in an inclined position with respect to the surface on which operating keys 112a are provided (operation surface section 112 of upper surface section 114).

As shown in FIG. 4, battery 116 and circuit board 117 are housed inside first case 110. Battery 116 is housed inside a housing section with an aperture in the bottom surface of first case 110, and this housing section is closed off by battery cover 102 forming part of the bottom of the first case. Also, second case 130 is provided with display surface 132 equipped with LCD (Liquid Crystal Display) panel 132a and LCD unit 132b, and the surface on the opposite side to the surface facing first case 110—that is, the upper surface—forms display surface 134.

As shown in FIG. 1, second case 130 overlaps first case 110 on upper surface section 114 so as to be movable along upper surface section 114, and this upper surface section 114 is provided with upper surface section 114 center section 118, and operation surface section 112 and inclined section 120 inclined upward from either end of center section 118 and separated in the sliding direction (here the longitudinal direction).

Operation surface section 112 is planar with operating keys 112a located thereupon, and forms an inclined surface forward of center section 118 extending in the longitudinal direction of first case 110. This operation surface section 112, and inclined section 120 inclined rearward of center section 118, are inclined symmetrically with respect to center section 118.

Center section 118 and inclined section 120 are formed by an upper part from the center part to the rear on both side wall sections 110b and 110c extending in the sliding direction (here, the longitudinal direction) in first case 110.

Center section 118 is formed by a center part of the upper sides of both side wall sections 110b and 110c, with the top surface as a surface parallel to the sliding direction—here, a horizontal surface parallel to display surface 134 of the second case placed in an overlapping position.

Here, inclined section 120 is formed by a rear area in which the top is inclined upward from an area of the center part of both side wall sections 110b and 110c. The rear ends of both side wall sections 110b and 110c are joined orthogonally to both edges of rear wall section 110a forming the rear surface of first case 110. A configuration may also be used in which a planar member is installed between both side wall sections 110b and 110c, and closes off the space between those both side wall sections 110b and 110c.

Operation surface section 112, center section 118, and inclined section 120 are each formed as having approximately the same length in the longitudinal direction, with the length of each here being approximately ⅓ of the overall length (longitudinal-direction length) of first case 110.

Thus, center section 118 and inclined section 120 in first case 110 having operation surface section 112 are surrounded by rear wall section 110a and an area rearward of the center part of both side wall sections 110b and 110c, and have a shape having an interior opening upward. Inside this aperture, plate-shaped slide base 152 of slide mechanism section 150 is installed. Here, slide base 152 is attached to first case 110 via screws (securing members) 153 parallel to the top edges of center section 118 extending in the longitudinal direction (the center parts of both side wall sections 110b and 110c).

Slide base 152 supports plate-shaped slider 154 so as to be able to slide in a linear direction in the longitudinal direction of the base plate of slide base 152. Second case 130 is attached to this slider 154 so as to be rotatable about an axis placed orthogonal to the sliding direction of slider 154 along the sliding surface with respect to the base plate of slider 154. Slider 154 may be installed in any way as long as the configuration allows for slider 154 to be installed so as to be able to slide in a linear direction with slide base 152.

Here, as shown in FIG. 1 and FIG. 4, slide base 152 is provided with groove sections 152a opening in mutually facing directions in both side parts in the longitudinal direction on the base plate forming the main-body part. Both side parts of plate-shaped slider 154 are inserted into these groove sections 152a so as to be able to slide in the extension direction of these groove sections 152a.

Slider 154 is installed in first case 110 so as to be able to move from a position where the second case overlaps, and slide in a linear direction as far as an exposing position where operation surface section 112 of first case 110 is exposed. On this slider 154, second case 130 is rotatably supported along the sliding surface (here, the sliding surface with slide base 152) via spindle sections 156 orthogonal to the sliding direction.

Specifically, bearing sections 157 rotatably supporting second case 130 via spindle sections 156 provided orthogonally to the sliding direction are provided in an upright orientation on the front edge of slider 154.

In this embodiment, bearing sections 157 are formed as approximately perpendicular plate-shaped pieces by bending front edge sections of plate-shaped slider 154 along the sliding direction (longitudinal direction). That is to say, when slider 154 is formed by processing a metal plate, bearing sections 157 are also integrally formed.

Bearing sections 157 formed in this way move linearly in center section 118 between a front end, which is boundary part 114a with respect to operation surface section 112, and a rear end, which is boundary part 114b with respect to inclined section 120, inward of both side parts of slide base 152, through the movement of slider 154.

A configuration has been assumed in which slide base 152 is located inside an aperture of center section 118 and inclined section 120, but slide base 152 may be installed in first case 110 in any way, as long as the part rotatably supporting second case 130 in slider 154 supported so as to be able to slide in the longitudinal direction moves smoothly in a linear direction between the front and rear of center section 118.

Slider 154 is biased toward the front with respect to slide base 152 by biasing member 161. Through the sliding of slider 154 resisting this biasing member 161 along slide base 152, bearing sections 157 slide from the front to the rear of center section 118 of first case 110—that is, over an area of the center part of upper surface section 114 of first case 110.

Here, biasing member 161 is formed by a slide toggle spring, with one end secured to slide base 152 by means of a screw, and the other end held in place by the rear end of slider 154.

As shown in FIG. 1, cutout sections 152b and 154b are formed at the front of slide base 152 and the front of slider 154. Inside these cutout sections 152b and 154b is located a board connecting circuitry inside first case 110 (circuit board 117 shown in FIG. 4, and so forth) to circuitry inside second case 130 (circuit board 136 shown in FIG. 4, and so forth)—here, FPC (Flexible Printed Circuit) 163.

FPC 163 is positioned so as to run through the front ends of slide base 152 and slider 154 from the front in such a way as not to impede the movement of slider 154.

On upper surface (display surface) 134, which is the surface of second case 130, is located LCD panel 132a comprising part of display surface 134, and keys 137a comprising cross-keys and so forth are located forward of (that is, on the base end side of) this LCD panel 132a. Also, rearward of (that is, on the tip side of) LCD panel 132a on display surface 134, are located speaker hole 137b with a speaker inside, and sub-camera hole 137c.

Second case 130 has an approximately flat plate shape, having an external shape similar to that of first case 110 in a plan view, and back surface section 140 opposite upper surface section 114 of first case 110 is formed in accordance with upper surface section 114 of first case 110.

That is to say, back surface section 140 of second case 130 is provided with center back surface section 142 having the same external shape as center section 118 of first case 110, and parallel to upper surface (display surface) 134, in its center part. Also, back surface section 140 is provided with front back surface section 144 and rear back surface section 146 inclined toward the base end side and tip side of upper surface (display surface) 134 of second case 130 respectively from both side parts separated in the longitudinal direction of center back surface section 142.

Thus, back surface section 140 of second case 130 has front back surface section 144 and rear back surface section 146 inclined from both side parts of center back surface section 142 having a surface parallel to display surface 134 so that the thickness of second case 130 gradually decreases toward one end (front end) 130c and the other end separated in the direction of movement on surface 134 of second case 130.

Front back surface section 144 and rear back surface section 146 are of approximately the same length in the longitudinal direction as center back surface section 142. Consequently, when second case 130 is positioned directly above first case 110—that is, when sliding-type portable terminal 100 is in the closed state—second case 130 overlaps first case 110, and sliding-type portable terminal 100 itself is flat and rectangular in shape.

Second case 130 is rotatably supported by bearing sections 157 of slider 154 via spindle sections 156 in the side surface sections of front end 142a consecutive to front back surface section 144 in center back surface section 142. That is to say, second case 130 is rotatably supported by bearing sections 157 of slider 154 in the vicinity of the junction between center back surface section 142 and front back surface section 144.

By means of these spindle sections 156, second case 130 is rotatable about an axial center extending in a direction (here, the shorter lateral direction) horizontally orthogonal to the sliding direction.

Rollers 139 that roll in contact with upper surface section 114 of first case 110 are attached to back surface section 140 of second case 130 at locations that slide over upper surface section 114 of first case 110. Rollers 139 may be located at any positions on second case 130, as long as these locations meet upper surface section 114 locations when sliding over upper surface section 114 of first case 110. Here, they are provided so as to be positioned below the bottom sections of both side wall sections of second case 130 located above both side wall sections 110b and 110c of first case 110.

FIG. 5 is a principal-part cross-sectional diagram showing a structure for attachment of a roller to second case 130 in sliding-type portable terminal 100 according to this embodiment.

As shown in FIG. 5, in sliding-type portable terminal 100 of this embodiment, roller housing section 130b is formed by notching in a downward direction part of a thick part of both side wall section 130a in second case 130, and roller 139 is installed inside this roller housing section 130b so as to be rotatable about an axis parallel to spindle section 156.

Roller 139 shown in FIG. 5 is shown as being installed in the vicinity of boundary part 130d between center back surface section 142 and rear back surface section 146 in second case 130, but the case is also similar if provided in front end 130c in both side wall section 130a of second case 130. That is to say, rollers 139 are installed rotatably inside both side wall sections in front end 130c from the bottom surface.

By this means, second case 130 can be slid smoothly by rolling when sliding along upper surface section 114 of first case 110.

Next, an operation whereby second case 130 is slid with respect to first case 110 in sliding-type portable terminal 100 having the above configuration will be described.

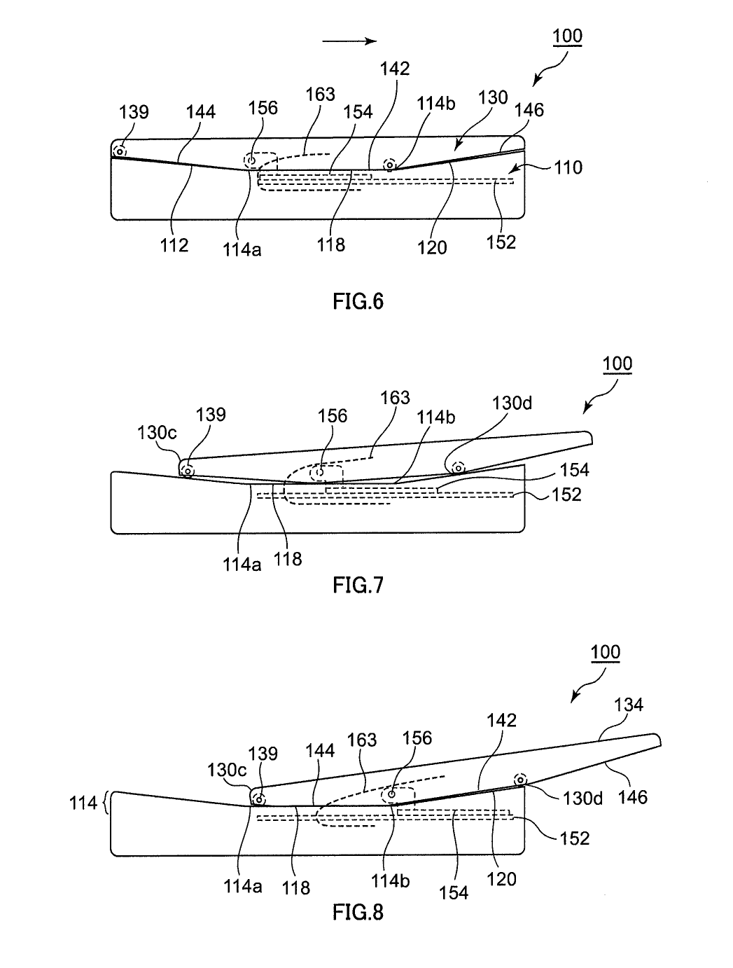

FIG. 6 through FIG. 8 are principal-part side views provided to explain an operation whereby second case 130 is slid with respect to first case 110 in sliding-type portable terminal 100 according to this embodiment.

FIG. 6 shows the positional relationship between spindle section 156, slider 154, and slide base 152 in a state in which operating keys 112a on sliding-type portable terminal 100 cannot be used (the closed state), as shown in FIG. 3.

As shown in FIG. 6, in a state in which second case 130 overlaps first case 110, front back surface section 144, center back surface section 142, and rear back surface section 146 of second case 130 are positioned respectively opposite operation surface section 112, center section 118, and inclined section 120 of first case 110.

That is to say, operation surface section 112 on which operating keys 112a are located is covered by front back surface section 144 of second case 130, and is therefore not exposed to the outside and cannot be used.

When sliding-type portable terminal 100 is in this state, if second case 130 is pushed longitudinally rearward (in the direction indicated by the arrow) with respect to first case 110, slider 154 connected to second case 130 via spindle section 156 moves linearly rearward on slide base 152. Together with this, second case 130 moves longitudinally rearward by sliding along upper surface section 114 of first case 110 (see FIG. 7). Also, FPC 163 connecting circuit board 136 of second case 130 (see FIG. 4) to circuit board 117 of first case 110 (see FIG. 4) is deformed in line with the movement of second case 130.

At this time, since roller 139 is located on second case 130 at a point of contact with first case 110, second case 130 moves smoothly along first case 110 through the rolling of roller 139 along upper surface section 114 of first case 110.

Specifically, rollers 139 located on the front end 130c side of second case 130 move over both edges of operation surface section 112, and rollers 139 located in the vicinity of boundary part 130d between center back surface section 142 and rear back surface section 146 move over inclined section 120 of first case 110 (to be specific, over the upper surfaces of the rear areas of both side wall sections 110b and 110c forming inclined section 120).

When second case 130 moves rearward along upper surface section 114 of first case 110 in this way, center back surface section 142 moves rearward over inclined section 120 of first case 110. By this means, upper surface (display surface) 134 of second case 130 inclines with respect to center section 118 of first case 110 from a state in which it is parallel to that center section 118.

When bearing section 157 moves as far as the rear end in center section 118 of first case 110 (boundary part 114b between center section 118 and inclined section 120), center back surface section 142 of second case 130 is located upon inclined section 120, as shown in FIG. 8. Rollers 139 located on the front end 130c side of second case 130 move from a position above both edges of operation surface section 112 to a position above the front ends of both side wall sections 110b and 110c.

At this time, upper surface 134, which is the display surface of second case 130, is inclined at the same angle as center back surface section 142 with respect to center section 118 of first case 110.

Also, in the state shown in FIG. 8, upper surface section 114 of second case 130 is located upon center section 118 of first case 110, and operation surface section 112 of first case 110 is exposed to the outside. That is to say, sliding-type portable terminal 100 is in the open state shown in FIG. 2—in other words, in a state in which operating keys 112a can be used.

In this state in which operating keys 112a can be used, front end 130c of upper surface (surface including the display surface) 134 of second case 130 is thinner than the thickness between upper surface 134 and center back surface section 142 in second case 130, and therefore upper surface 134 of second case 130 is located at a position at which it is inclined, with almost no difference in level, with respect to operation surface section 112 of first case 110. Here, the intersecting plane of upper surface 134 and operation surface section 112 of first case 110 exposed to the outside form an obtuse angle.

Also, when sliding-type portable terminal 100 is in the closed state, the rear of second case 130 is located at a position protruding rearward from the rear of first case 110 (specifically, rear wall section 110a)—that is, in an overhanging position—and rear back surface section 146 is exposed to the outside.

According to sliding-type portable terminal 100 configured in this way, slider 154 that slides linearly with respect to slide base 152 fixed to one of first case 110 and second case 130 has the other connected thereto rotatably about an axis that follows a sliding surface and is orthogonal to the sliding surface. Then, by sliding the other with respect to the one following the shape of a sliding part of the one, a display surface of second case 130 is positioned at a position at which the display surface of second case 130 is inclined with respect to a surface of first case 110 on which operating keys 112a are located.

Thus, it is not necessary, as hitherto, to connect a lower case and an upper case overlapping the lower case using a rail that curves upward over the entire longitudinal area of both cases as viewed from the side when the upper surface of the upper case is moved to a position where it is inclined with respect to the upper surface of the lower case. Consequently, the thickness of the mobile phone itself (the set thickness) does not increase by the height from the bottom to the top of the rail, and thinness can be achieved.

Also, since it is not necessary to use a curved rail requiring a high degree of precision in the manufacturing process, manufacturing costs can be reduced.

Moreover, since slide base 152 and slider 154 that slide relatively linearly are used, existing slider 154 and slide base 152 that slide in a relatively linear direction can be processed and used, it is not necessary to newly prepare a curved rail, and manufacturing costs can be reduced.

Furthermore, since it is not necessary to form a platform part by notching both side parts of the upper surface section of the lower case, and provide a convex part detachably engaged in a guide groove of a skirt part in the upper case, it is not necessary to increase the lateral width of the lower case itself.

Thus, according to this embodiment, a state can be established in which operation surface section 112 of first case 110 and display surface 134 of second case 130 are positioned at a predetermined angle (here, an obtuse angle) by means of a simple configuration using slide mechanism section 150 of a structure that is relatively displaced in a linear direction, without using a curved rail. Therefore, a sliding-type portable terminal can be implemented that enables thinness and small size to be achieved together with an improvement in operability.

Also, since sliding-type portable terminal 100 is assumed to be a mobile phone, during a call the upper part of second case 130 in which a speaker is provided and the lower part of first case 110 in which a microphone is provided can be positioned close to a user's ear and mouth respectively.

Moreover, according to sliding-type portable terminal 100, in the closed state, spindle sections 156 that are supporting points for second case 130 with respect to first case 110 are located in the vicinity of boundary part 114b between center section 118 and inclined section 120 of first case 110. Also, in the open state, front end 130c of second case 130 is positioned above the front end of center section 118 in first case 110 (boundary part 114a between center section 118 and operation surface section 112). Furthermore, in the open state, the rear end of center back surface section 142 of second case 130 (the boundary part between center back surface section 142 and rear back surface section 146) is positioned above the rear end (rear wall section 110a) of inclined section 120.

Consequently, if a load is applied to second case 130 from above by the user when using sliding-type portable terminal 100 in the open state, a point of load or point of effort is positioned between a location where spindle sections 156 constituting a fulcrum with respect to first case 110 (in the vicinity of the center section) and a position approximately equally distant in the longitudinal direction, as viewed from the side. Therefore, when sliding-type portable terminal 100 is in the open state, first case 110 can stably bear a load applied to second case 130.

In sliding-type portable terminal 100, second case 130 is connected to first case 110 only in an area of center section 118 of first case 110 that is not exposed to the outside when slid with respect to first case 110 via slide mechanism section 150. Also, bearing sections 157 are formed as plate-shaped pieces rising from slider 154, and rotatably connect second case 130 over the sliding direction (longitudinal direction) width.

Consequently, even when placed in an open state in which second case 130 is slid to expose operating keys 112a to the outside, sliding-type portable terminal 100 the structure of the part connecting first case 110 and second case 130 is not exposed to the outside, and both design and appearance are better then hitherto.

An embodiment of the present invention has been described above. Sliding-type portable terminal 100 according to the present invention is not limited to the above-described embodiment, and various variations and modifications may be possible without departing from the scope of the present invention.

Inclined section 120 of first case 110 has been shown as being configured by means of rear parts of both side wall sections 110b and 110c extending in the sliding direction (longitudinal direction) of second case 130, but may be formed in any way as long as it guides center back surface section 142 of sliding second case 130 to a position where center back surface section 142 is inclined with respect to center section 118. That is to say, an inclined section on which moving center back surface section 142 of second case 130 slides may be provided in any way at the rear of first case 110.

The disclosure of Japanese Patent Application No. 2008-168828, filed on Jun. 27, 2008, including the specification, drawings and abstract, is incorporated herein by reference in its entirety.

### INDUSTRIAL APPLICABILITY

A sliding-type portable terminal according to the present invention has an effect of enabling thinness and small size to be achieved together with an improvement in operability, and is suitable for use as a sliding-type portable terminal such as a mobile phone in which a display section and an operation section are provided in separate cases, and these cases are connected in a slidable fashion.

1. A sliding-type portable terminal that is provided with a first case having one surface that includes an operation surface on which operating keys are located, and a second case that has a display section on the surface side, and is connected to the first case so as to be movable from an overlapping position on the one surface to an exposing position where the operation surface is exposed to the outside, the sliding-type portable terminal comprising:
a sliding member that is attached to the first case so as to be able to slide freely in a linear direction from the overlapping position to the exposing position, and rotatably supports the second case along a sliding surface on an axis placed orthogonal to the sliding direction; and
an inclined section that is provided on the first case, and on which the second case slides together with sliding of the sliding member in a linear direction, and that causes a surface of the second case to incline toward the operation surface side.

2. The sliding-type portable terminal according to claim 1, wherein:
a back surface in the second case comprises a center back surface section having a surface parallel to a surface of the second case, and one inclined back surface section and another inclined back surface section such that a thickness of the second case gradually decreases from both side parts of the center back surface section toward one end and another end, the both side parts being separated in the direction of movement of the second case in the case back surface section, and the one end and the another end being separated in a direction of movement on a surface of the second case;
the one surface of the first case has a shape in accordance with a back surface shape of the second case overlapping that one surface;
the sliding member is installed on one surface of the first case so as to be able to slide freely in a linear direction on a slide base installed in a center part corresponding to a center back surface section of the second case, and makes a location rotatably supporting the second case movable between one end and another end separated on the direction of movement side in the center section;
the operation surface is formed at a location inclined from an end on the one end side of the center section, and facing to the one inclined back surface section;
the inclined section is formed as a location inclined from an end on the other end side of the center section, and facing to the other inclined back surface section; and
the second case is rotatably supported by the sliding member in the vicinity of a junction between the center back surface section and the one inclined back surface section.

3. The sliding-type portable terminal according to claim 1, further comprising a roller that rolls in a sliding direction at a location at which one of the first case and the second case slides against the other case.
